(19) United States
(12) Patent Application Publication
(10) Pub. No.: US 2015/0288988 A1
(43) Pub. Date: Oct. 8, 2015

(54) VIDEO TRANSMISSION TERMINAL, VIDEO TRANSMISSION METHOD, VIDEO TRANSMISSION PROGRAM, AND VIDEO TRANSFER SYSTEM

(71) Applicant: PANASONIC INTELLECTUAL PROPERTY MANAGEMENT CO., LTD., Osaka (JP)

(72) Inventor: Kenji OOl, Kanagawa (JP)

(73) Assignee: PANASONIC INTELLECTUAL PROPERTY MANAGEMENT CO., LTD., Osaka (JP)

(21) Appl. No.: 14/437,531

(22) PCT Filed: Oct. 22, 2013
(86) PCT No.: PCT/JP2013/006228

§ 371 Date: Apr. 22, 2015

(30) Foreign Application Priority Data
Nov. 7, 2012 (JP) 2012-245142

(51) Int. Cl. H04N 21/2187; H04N 7/18; H04N 21/4223; H04N 21/4363; H04N 21/2385

(52) U.S. Cl. CPC H04N 21/2187; H04N 21/43637; H04N 21/2385; H04N 21/4223; H04N 7/185

(57) ABSTRACT

To alleviate deterioration in a video associated with the search for access points in a video transfer system for transferring the video in real time. A video transmission terminal of a video transfer system includes a transmission/reception unit that transmits video data to a video receiving device via any of a plurality of access points, and a handover processing unit that scans the plurality of access points to be scanned for handover, the scan being segmented into a plurality of times of scans. The transmission/reception unit is configured not to transmit at least some of frames of the video data to be transmitted during the segmented scan.

### CROSS-REFERENCE TO RELATED APPLICATION

The present application claims the benefit of priority from Japanese Patent Application No. 2012-245142 filed in Japan on Nov. 7, 2012, the entire contents of which are incorporated herein by reference.

1. Technical Field

The present invention relates to a video transmission terminal, a video transmission method, a video transmission program, and a video transfer system for transmitting video data to a video receiving device via any of a plurality of access points.

2. Background Art

Conventionally, a video transfer system is known in which a video transmission terminal, while capturing an video, wirelessly transmits video data to a video receiving device in real time using wireless local area network (WLAN) technology, and in which the video is reproduced in real time on the video receiving device. In such a video transfer system, a video transmission terminal is applied as a wearable camera to be worn by police and security staff, and a video receiving device is applied as a surveillance system, a safety system, a security system or the like installed in a surveillance center.

A plurality of access points is provided, spaced away from each other, to a place for imaging. The video data produced by the video transmission terminal is transmitted to the video receiving device via any of the plurality of access points. In general, the plurality of access points is provided so that the coverage areas of individual access points partially overlap each other. A coverage area is an area where the communication with the video transmission terminal is available.

In the case where the video transmission terminal moves while imaging, going out of the coverage area of an access point to which the terminal is currently connected, or in the case where another access point is found where more stable communication is available, handover processing for switching the access points is performed. In the video transmission terminal, a background scan (hereafter referred to as “scan”) is performed to search for an access point to be connected.

The following are the prior-art documents, as the prior arts related to the present invention.

### CITATION LIST

### Patent Literature

Patent Literature 1: JP 2008-98880 A
Patent Literature 2: JP 2007-325067 A
Patent Literature 3: JP 2005-151433 A

### SUMMARY OF INVENTION

### Technical Problem

However, data cannot be transmitted during the scan, and thus a reproduced video may be disturbed on the video receiving device, on which the video is being reproduced in real time. FIGS. 6 and 7 are diagrams illustrating deterioration of a video associated with access point search. As illustrated in FIG. 6, this video transfer system has 14 types of access points AP1 to AP14 with communication channels (frequencies) different from one other. These access points are provided so that the coverage areas of the same kind of access points do not overlap each other.

In a search for an access point to connect, all the 14 channels are scanned during the handover processing. As illustrated as an example in FIG. 6, when an access point search is performed by the video transmission terminal connected to the access point AP1 of a channel 1, the video transmission terminal sets a frequency to one channel, and broadcasts a probe request Rq and waits for a probe response Rs from the corresponding access point. It takes 30 to 100 milliseconds before the probe response Rs is returned.

As illustrated in FIG. 6, searching for an access point to connect by conducting the above process in sequence for all access points with changed frequencies may require about several hundred milliseconds to one second. As illustrated in FIGS. 6 and 7, the transmission of video data FR is interrupted during this duration of about several hundred milliseconds to one second.

While transmission of the video data is being interrupted by the scan for the access points, the video transmission terminal continues imaging, with the video data encoded in sequence. The video data is stored in a buffer and will be transmitted after the scan ends. When the scan takes a long time, or the capacity of the buffer is not sufficient, however, it is not possible to store in the buffer all of the interrupted video data, which may cause partially discarded data and deterioration in the video. In addition, when the video data stored in the buffer is continuously transmitted after the scan, a frame rate becomes faster on the reproduction side, also deteriorating the image quality of the video.

In the example of FIG. 7, the scan is started after the transmission of a frame 2 and, encoded frames are to be stored in the buffer on the video transmission terminal. In this example, however, the video data of a frame 3 and part of the video data of a frame 4 are discarded because of insufficient capacity of the buffer. Thus, even if the video data stored in the buffer is transmitted after the scan, the video data of the frame 3 and part of the video data of the frame 4 cannot reach the receiving side; both frames will result in reproduction failures (loss). Regarding frames 5 to 7, the video data stored in the buffer during the scan are transmitted continuously after the scan, making frame intervals shorter, thus deteriorating the image quality on the receiving side.

Patent Literature 2 and 3 disclose techniques to reduce the time for scan to prevent deterioration in the image quality, including: a technique to scan only specified channels at predetermined time intervals, and a technique to segment the channels to be scanned into a plurality of groups, for which the scan is done per group at every scan instruction timing. Even by using the above techniques, however, it is still difficult to avoid an occurrence of reproduction failure or image quality deterioration, although the time for each scan may be reduced.

The present invention has been made in view of the problem as described above, and an object of the present invention is to greatly reduce the video quality deterioration associated with the search for access points, in a video transfer system that transfers videos in real time.

### Solution to Problem

A video transmission terminal includes a transmission unit configured to transmit video data to a video receiving device via any of a plurality of access points, and a handover processing unit configured to scan the access points for handover. The transmission unit is configured not to transmit at least some of frames of the video data to be transmitted during the scan.

A video transmission program causes a computer to execute a transmission step of transmitting video data to a video receiving device via any of a plurality of access points, and a handover processing step of scanning the access points for handover. In the transmission step, at least some of frames of the video data to be transmitted during the scan is not transmitted.

A video transmission method includes a transmission step of transmitting video data to a video receiving device via any of a plurality of access points, and a handover processing step of scanning the access points for handover. In the transmission step, at least some of frames of the video data to be transmitted during the scan is not transmitted.

A video transfer system includes a video transmission terminal and a video receiving device. The video transfer system is configured to transfer video data from the video transmission terminal to the video receiving device. The video transmission terminal includes a transmission unit configured to transmit the video data to the video receiving device via any of a plurality of access points, and a handover processing unit configured to scan the access points for handover. The transmission unit is configured not to transmit at least some of frames of the video data to be transmitted during the scan, and configured to transmit an advance notice of the scan to the video receiving device before performing a segmented scan. The video receiving device includes a reception unit configured to receive the video data and the advance notice, a reproduction unit configured to reproduce the video data, and a reproduction control unit configured to, in response to the advance notice, adjust the timing of reproducing, by the reproduction unit, the video data that has been received after the advance notice and before the scan.

### Advantageous Effects of Invention

According to the present invention, a scan for handover is performed without transmitting a certain frame. Therefore, there will be no continuous transmission, after the scan is completed, of the video data suspended during the scan, making it possible to reduce or avoid uneasiness for users, caused by the reproduction of the video data with an increased frame rate on the receiving side.

As will be described below, other aspects exist in the present invention. Accordingly, the disclosure of the present invention is intended to provide some aspects of the present invention and is not intended to limit the scope of the invention as described and claimed herein.

### BRIEF DESCRIPTION OF DRAWINGS

FIG. 1 is a block diagram illustrating a configuration of a video transfer system according to a first embodiment of the present invention.

FIG. 2 is a sequence diagram of a video data transfer according to the first embodiment of the present invention.

FIG. 3 is a sequence diagram of the video data transfer according to the first embodiment of the present invention.

FIG. 4 is a block diagram illustrating a configuration of a video transfer system according to a second embodiment of the present invention.

FIG. 5 is a sequence diagram of a video data transfer according to the second embodiment of the present invention.

FIG. 6 is a sequence diagram of a conventional video data transfer.

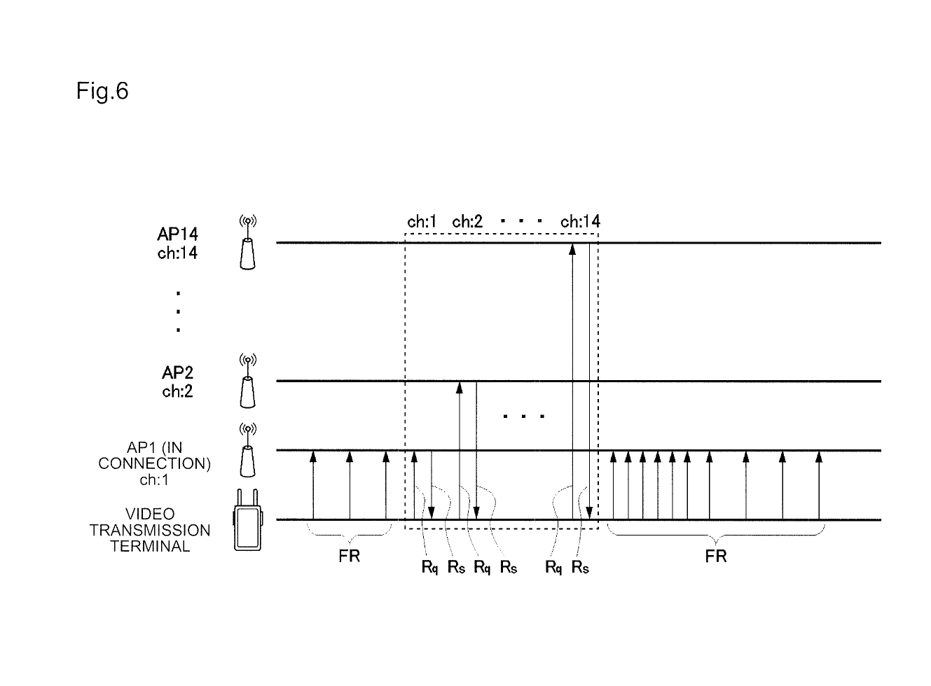

FIG. 7 is a sequence diagram of a conventional video data transfer.

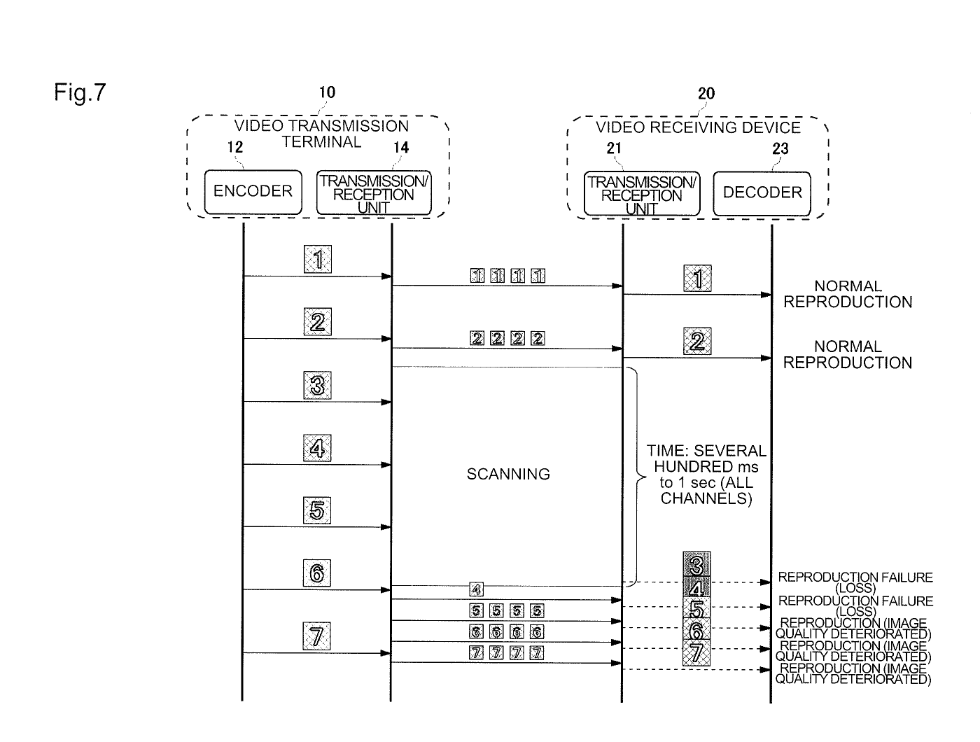

### DESCRIPTION OF EMBODIMENTS

The following is a detailed description of the present invention. The embodiments described below are examples of the present invention, and the present invention can be modified in various aspects. Therefore, the specific configurations and functions disclosed below are not intended to limit the scope of the claims.

A video transmission terminal according to an embodiment includes a transmission unit configured to transmit video data to a video receiving device via any of a plurality of access points, and a handover processing unit configured to scan the access points for handover. The transmission unit is configured not to transmit at least some of frames of the video data to be transmitted during the scan.

With this configuration, the video data suspended during the scan are not continuously transmitted after the completion of the scan, making it possible to reduce or avoid uneasiness for users, caused by the reproduction of the video data with an increased frame rate on the receiving side. In addition, canceling the transmission of a portion of the frames of the video data makes it possible to reduce the load on a communication network used for transferring the video data.

In the above-described video transmission terminal, the handover processing unit may segment a scan for access points into a plurality of times of scans to be implemented.

This configuration makes it possible to reduce individual periods of time unavailable for the video data transmission caused by each segmented scan.

In the above video transmission terminal, the video data frame that is not to be transmitted may be the frame immediately before an intra-frame coding frame.

With this configuration, after the scan ends, the intra-frame coding frame, which is self-decodable, is to be transmitted first. This makes it possible to avoid an inconvenience, caused by a missing reference frame, of unsuccessful reproduction of the frame that is to reference the frame canceled during the scan.

The video transmission terminal may transmit an advance notice of the scan to the video receiving device, before performing the segmented scan.

With this configuration, the video receiving device that receives the video data can determine that the video data transmission will be interrupted because of the scan. Thus, the video receiving device can adjust the timing of reproducing the video data, received after the transmission of the advance notice of the scan and before the scan is performed.

A video transmission program according to an embodiment causes a computer to execute a transmission step of transmitting video data to a video receiving device via any of a plurality of access points, and a handover processing step of scanning the access points for handover. In the transmission step, at least some of frames of the video data to be transmitted during the scan is not transmitted.

Also with this configuration, the scan for the plurality of access points for handover is segmented into a plurality of times of scans. Thus, it is possible to reduce the time unavailable for the video data transmission caused by each segmented scan, and to suppress the video quality deterioration in reproduction of the video on the video receiving device that receives the video data.

A video transmission method according to an embodiment includes a transmission step of transmitting video data to a video receiving device via any of a plurality of access points, and a handover processing step of scanning the access points for handover. In the transmission step, some of frames of the video data to be transmitted during the scan is not transmitted.

Also with this method, the scan for the plurality of access points for handover is segmented into a plurality of times of scans. Thus, it is possible to reduce the time unavailable for the video data transmission caused by each segmented scan, and to suppress the video quality deterioration in reproduction of the video on the video receiving device that receives the video data.

A video transfer system according to an embodiment includes a video transmission terminal and a video receiving device, and transfers video data from the video transmission terminal to the video receiving device. The video transmission terminal includes a transmission unit configured to transmit the video data to the video receiving device via any of a plurality of access points, and a handover processing unit configured to scan the access points for handover. The transmission unit is configured not to transmit at least some of frames of the video data, to be transmitted during the scan, and is configured to transmit an advance notice of the scan to the video receiving device before performing a segmented scan. The video receiving device includes a reception unit configured to receive the video data and the advance notice, a reproduction unit configured to reproduce the video data, and a reproduction control unit configured to, based on the advance notice, adjust the timing for the reproduction unit to reproduce the video data that has been received after the advance notice and before the scan.

With this configuration, the scan for the plurality of access points for handover is segmented into a plurality of times of scans. This reduces the time unavailable for the video data transmission caused by each segmented scan, suppresses video quality deterioration in the reproduction of the video on the video receiving device that receives the video data, and alleviates the unevenness in the time interval of the reproduced frames, caused by the interrupted transmission of the video data due to the scan, making it possible to reproduce the video more smoothly.

Hereafter, video transfer systems according to embodiments of the present invention will be described with reference to the attached drawings.

### First Embodiment

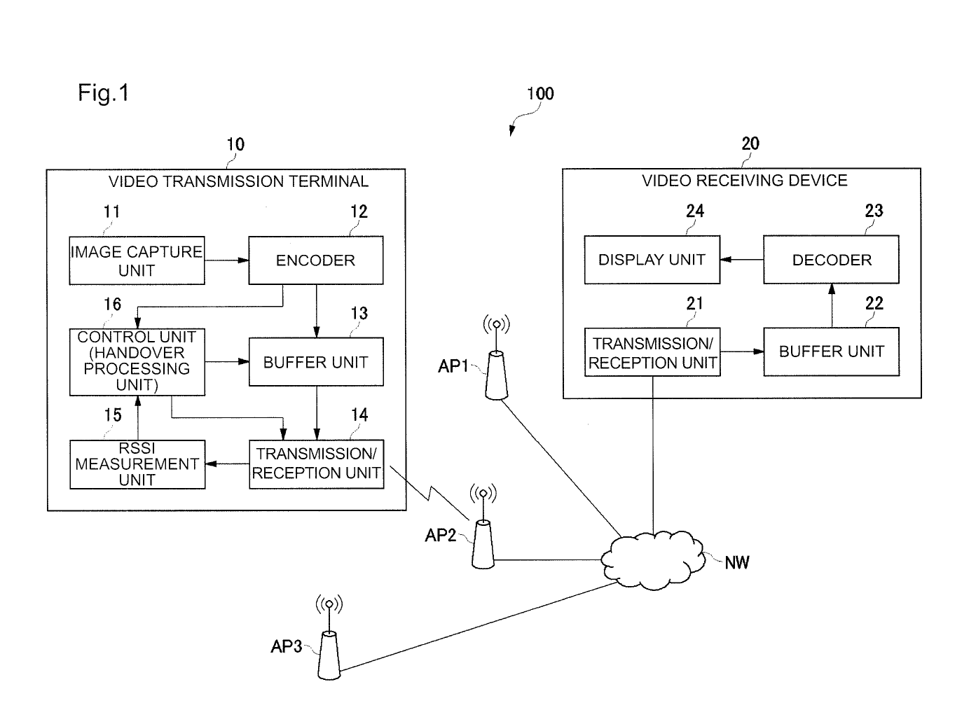

FIG. 1 is a diagram illustrating a configuration of a video transfer system 100 according to a first embodiment of the present invention. The video transfer system includes a video transmission terminal 10 and a video receiving device 20. The video transmission terminal 10 is connected to any of a plurality of access points AP1 to AP3, and transmits video data to the video receiving device 20 via the access point connected.

Each of the plurality of access points AP1 to AP3 has its own coverage area where communication with the video transmission terminal 10 is possible. The coverage areas of an access point and another adjacent access point partially overlap. The video transmission terminal 10 uses WLAN to connect with any of the plurality of access points AP1 to AP3 to perform data communication. The video receiving device 20 connects with each of the access points AP1 to AP3 via a network NW to perform data communication.

The video transfer system 100 of the present embodiment has 14 channels, any of which is allocated to each of the access points. Different channels are allocated to adjacent access points. The video transmission terminal 10, when performing wireless communication with an access point, transmits or receives radio waves with a frequency corresponding to the channel of the access point.

The video transmission terminal 10 has a function to capture a video to produce video data, and a function to wirelessly transmit the video data to the access point using WLAN. The video transmission terminal 10 is a wearable camera, for example, and accesses any of the plurality of access points while moving among these access points.

The video transmission terminal 10 transmits, in real time, the video data that has been obtained by image capturing. The term “real time”, as used herein, is not used for representing permanent storage of the video data produced by imaging into the video transmission terminal 10 and transmitting the stored video data at any given time, but for representing transmitting the produced video data immediately. Note that even if the video data is temporarily stored in a buffer for transmission, the real-time performance is maintained.

The video transmission terminal 10 includes an image capture unit 11, an encoder 12, a buffer unit 13, a transmission/reception unit 14, a received signal strength indicator (RSSI) measurement unit 15, and a control unit 16. The control unit 16, according to an instruction from a user and a video transmission program, controls a part or whole of the video transmission terminal 10, including handover processing described later. Hereafter, the control unit 16 that performs the handover processing is also called a handover processing unit. The video transmission program may be executed by being downloaded to the video transmission terminal 10 via a network, or by being read from a predetermined storage medium and stored in a storage unit (not illustrated) of the video transmission terminal 10, and then read from the storage unit.

The image capture unit 11 includes an optical system having a plurality of lenses, and an imaging element as a photoelectric conversion element, and converts an optical image of an object into a signal for each pixel. The signal for each pixel is input as a video signal into the encoder 12.

The encoder 12 is configured to encode video signals input from the image capture unit 11 to produce the video data. The video data is produced for each frame. The encoder 12 of the present embodiment is configured to perform an inter-frame prediction coding according to moving picture experts group (MPEG). In the inter-frame prediction coding, an intra-frame coding is performed for one frame of every 1 group of pictures (GOP), for example, and a forward inter-frame prediction coding is performed for the other frames in 1 GOP. In the present embodiment, a frame encoded by the intra-frame coding is called an I frame, and a frame encoded by the inter-frame coding is called a P frame. Note that the GOP also includes a bidirectional inter-frame prediction coding frame called a B frame; however, to simplify the description in the present embodiment, examples of the I frame and the P frame will be described. The present invention is also applicable in the case where the B frame exists. The encoder 12 further packetizes the data of each frame that has been encoded. The packet is stored into the buffer unit 13 in the order of production.

The buffer unit 13 temporarily stores the packet of the video data that has been encoded at the encoder 12. The buffer unit 13 having a capacity to store several frames of video data is sufficient. The buffer unit 13 outputs the video data in the order of input.

The transmission/reception unit 14 transmits the video data. The transmission/reception unit 14 modulates carrier waves of the frequency of the connected access point, according to the video data, and then transmits the carrier waves. As described above, the access points use different channels and different frequencies for the radio waves to be transmitted and received. Thus, the transmission/reception unit 14 transmits or receives the radio waves of the frequency corresponding to the channel of the access point connected.

The RSSI measurement unit 15 measures the received signal strength based on the reception status of the radio wave at the transmission/reception unit 14. The handover processing unit 16 performs handover processing. The handover processing unit 16 starts the handover processing at predetermined intervals. The handover processing unit 16 also starts the handover processing when the received signal strength that has been measured at the RSSI measurement unit 15 is lower than a predetermined threshold value.

The handover processing unit 16 scans a plurality of access points for handover processing. At this scan, the transmission/reception unit 14 transmits, to each access point, a probe request with a frequency varied corresponding to the channel of the access point, based on the control of the handover processing unit 16, and waits for a probe response from the corresponding access point suitable for the frequency. In the handover processing, scans need to be performed for the plurality of access points one by one. A method of this scan will be described later.

The video receiving device 20 includes a transmission/reception unit 21, a buffer unit 22, a decoder 23, and a display unit 24. The video receiving device 20 may be an ordinary personal computer having a display monitor.

The transmission/reception unit 21 receives the video data, transmitted from the video transmission terminal 10 via any of the plurality of access points AP1 to AP3. The buffer unit 22 temporarily stores the received video data and outputs the video data to the decoder 23 at a suitable timing. The decoder 23 decodes the encoded video data to produce a video signal. In the present embodiment, the video data has been encoded using the inter-frame coding. The decoder 23 decodes the video data in a way corresponding to this type of coding. The display unit 24 displays the video according to the video signal produced at the decoder 23. The configuration including the decoder 23 and the display unit 24 is equivalent to a reproduction unit for reproducing the video data.

With the above configuration of the video receiving device 20, the video data is reproduced, enabling a user of the video receiving device 20 to view the video. The video receiving device 20 reproduces video in real time. That is, upon receiving the video data, the video receiving device 20 reproduces the received video data immediately, instead of permanently storing the video data into the video receiving device 20 and reproducing the stored video data at any given time. Note that even when the video data is temporarily stored in a buffer for reproduction, the real-time performance is maintained. Further, even when the received video data is permanently stored in parallel with a real-time reproduction, the real-time performance is also maintained.

With the real-time video data transmission on the video transmission terminal 10 and the real-time reproduction of the video on the video receiving device 20, the video imaged by the image capture unit 11 of the video transmission terminal 10 is displayed in real time on the display unit 24 of the video receiving device 20.

The following describes processing for scanning an access point for handover, performed on the video transmission terminal 10. The handover processing unit 16 scans an access point for handover at predetermined intervals. The handover processing unit 16 also performs the scan for handover when the received signal strength at the RSSI measurement unit 15 is lower than a predetermined threshold value. When another access point having better radio wave conditions than the access point currently connected is found during the scan, the handover processing unit 16 performs the handover processing to switch to the access point having better radio wave conditions.

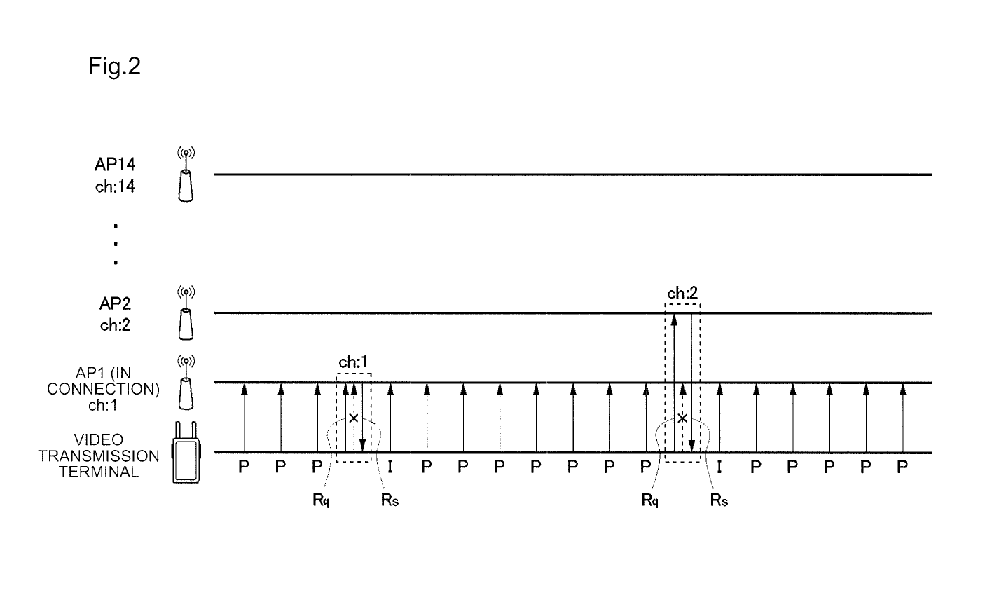

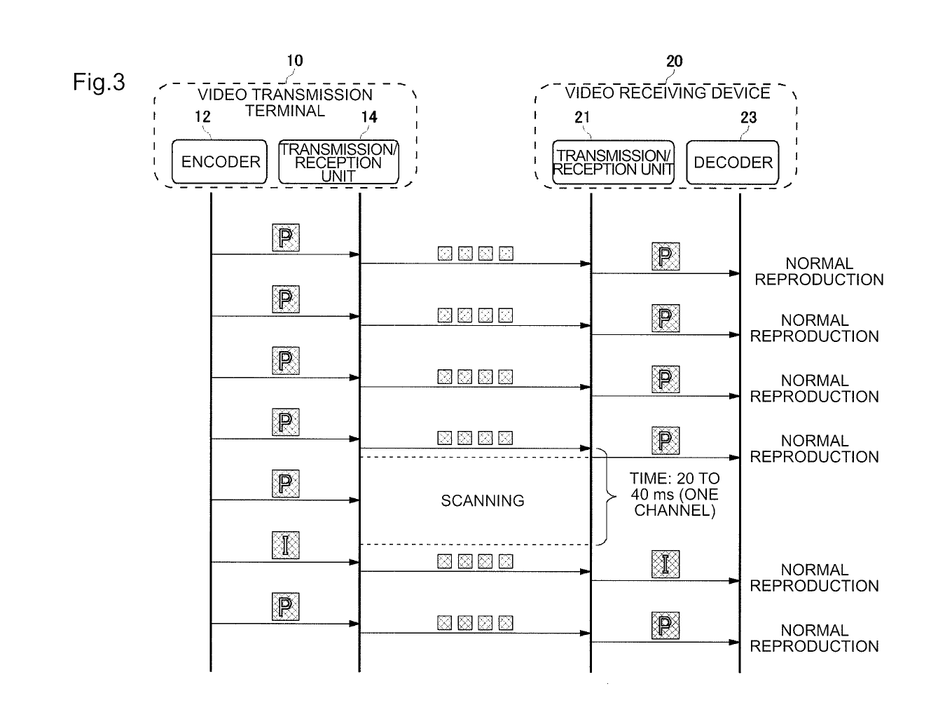

FIGS. 2 and 3 are sequence diagrams illustrating examples of the video data transfer of the present embodiment. In FIG. 2, “I” and “P” represent the I frame video data and the P frame video data, respectively, and “Rq” and “Rs” represent a probe request and a probe response, respectively. In FIG. 3, the boxed “I” and “P” represent the I frame video data and the P frame video data, respectively, and small squares being transferred from the video transmission terminal 10 to the video receiving device 20 in the diagram represent packets of the video data for each frame.

As shown in FIGS. 2 and 3, the video transmission terminal 10 of the present embodiment scans a plurality of access points to be scanned for handover, not continuously but by segmenting the scan into a plurality of times of scans. Hereafter, each scan obtained by segmentation is referred to as a “segmented scan”. In each segmented scan, the scan is performed for a part of the plurality of access points to be scanned for handover. The scan for the plurality of access points is segmented for each access point (for each channel). In the present embodiment, the segmented scan is performed for one access point (one channel) at a time.

The time needed to perform the scan for one channel, i.e., the time required to complete the transmission of a probe request to one access point and the reception of a probe response from the same access point is 20 to 40 milliseconds. Assuming that the frame rate of the video data is 30 fps, the frame interval will be 33 milliseconds, and thus the time required for the segmented scan for one channel will be shorter than twice the frame interval.

The handover processing unit 16 cancels the transmission of the frame to be transmitted during the segmented scan. That is, the handover processing unit 16 deletes a packet for the frame to be transmitted during the scan, among the frames stored in the buffer unit 13. This eliminates the need, at each end of the segmented scan, for conducting continuous transmissions of the frames that have been suspended during the segmented scan and the frames that have been newly produced, thus preventing the frame rate from increasing also on the receiving side.

According to the present embodiment, as described above, the time required for the segmented scan is shorter than twice the frame interval, and thus it is sufficient to cancel one frame for the segmented scan. The video data in the frame to be transmitted during the segmented scan cannot be obtained on the video receiving device 20. The lack of one frame, however, may rarely be perceived by the user when the video data is reproduced, and the lack of one frame rarely causes the deterioration of the video.

The handover processing unit 16 cancels the P frame immediately before the I frame, for the segmented scan. In other words, the handover processing unit 16 adjusts the timing of the segmented scan so that the first frame to be transmitted after the segmented scan would be the I frame. According to the present embodiment, one frame is to be canceled by the segmented scan; therefore, this one frame is to be the P frame immediately before the I frame. Accordingly, the handover processing unit 16 starts the segmented scan after the transmission of the second last P frame before the I frame.

As described above, the encoder 12 uses the inter-frame coding to encode the video data, and the P frame is reproduced with reference to another frame. Thus, canceling the transmission of a certain frame may cause an inconvenience that a frame to be reproduced with reference to the canceled frame results in a reproduction failure on the receiving side. In the present embodiment, on the other hand, the I frame, which is self-reproducible, is transmitted after the segmented scan, making it possible to avoid such an inconvenience. In this regard, reducing the frames unreproducible on the receiving side can suppress deterioration of the video.

As described above, the handover processing unit 16 scans the access points at predetermined intervals, and also scans the access points when the received signal strength has lowered. In these cases, the segmented scan is not performed immediately but waits for the transmission timing of the frame immediately before the I frame. More specifically, the segmented scan is performed after completion of the transmission of the second last frame before the I frame. The handover processing unit 16, by counting the number of the P frames after the transmission of the I frame, determines that the second last P frame before the I frame has been transmitted.

In the video transfer system 100 according to the present embodiment, 14 access point channels are provided. In each segmented scan, the scan for one channel is performed. Therefore, the handover processing unit 16 segments the scan for the access points into 14 segmented scans. Each segmented scan is carried out for each P frame immediately before the I frame, i.e., for every GOP.

As described above, in the video transfer system according to the present embodiment, each scan performed for the plurality of access points to be scanned for handover is segmented into a plurality of scans, and the segmented scans are performed a plurality of times. This makes it possible to reduce the time for one scan (the segmented scan) and to alleviate the deterioration of the video. Additionally, transmission is canceled for the frames to be transmitted during the segmented scan. Thus, after the segmented scan, the frames to be transmitted during the scan will not be sent together, enabling the reduction of a load on a communication network. On the receiving side, after the segmented scan, there will be no need to reproduce the suspended frames with an increased frame rate, also making it possible to alleviate the deterioration of the video.

Furthermore, the segmented scan is done immediately before the I frame, namely, the I frame is to be transmitted following the segmented scan. Therefore, an inconvenience that may be caused by a missing frame to be referenced due to the canceled transmission of the frame, i.e. an inconvenience that a frame referencing the missing frame cannot be successfully reproduced, although the frame referencing the missing frame has reached the video receiving device, can be avoided. This can also alleviate the deterioration of the video.

The above embodiment has described the segmented scan that uses the time to transmit one frame. The time for the segmented scan, however, may be the time for transmitting two or more frames. Furthermore, in the above embodiment, one channel is scanned in each segmented scan. The number of channels to be scanned in each segmented scan, however, may be two or more.

For a system configuration in which the total number of access points is two, the number of channels to be scanned would be one. In this case, there is no need to perform the segmented scan; it would be sufficient to scan only one channel in order to scan another access point other than the one currently in communication.

### Second Embodiment

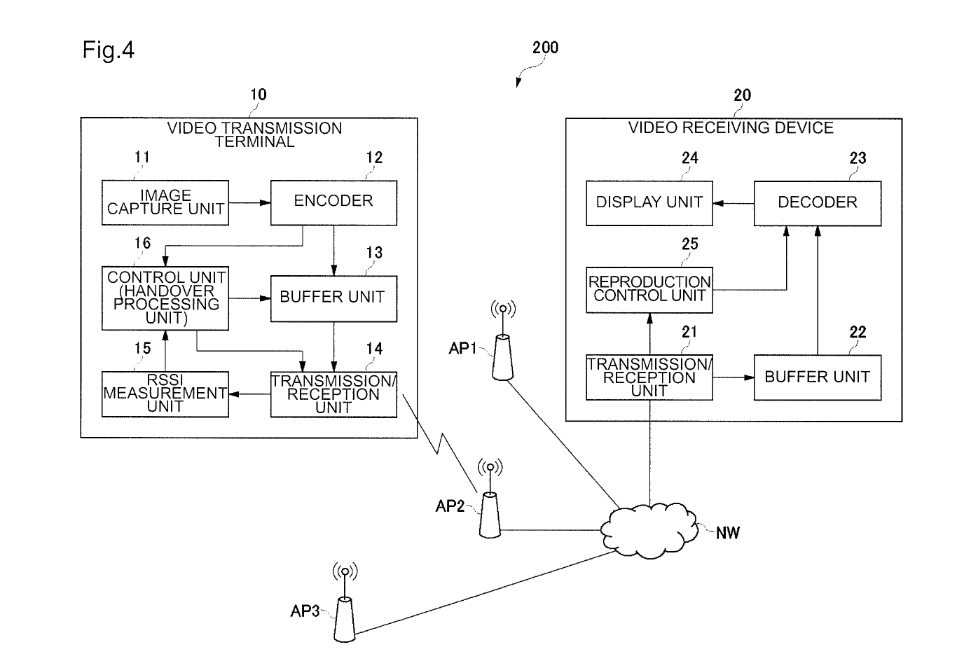

FIG. 4 is a block diagram illustrating the configuration of a video transfer system according to a second embodiment of the present invention. In a video transfer system 200 illustrated in FIG. 4, description of the configuration similar to the video transfer system 100 in the first embodiment will be omitted by using the same reference signs as in the first embodiment.

The video transfer system 200 of the present embodiment includes a video transmission terminal 10, a plurality of access points AP1 to AP3, and a video receiving device 20, in the same manner as in the video transfer system 100 of the first embodiment. The video transmission terminal 10 includes an image capture unit 11, an encoder 12, a buffer unit 13, a transmission/reception unit 14, an RSSI measurement unit 15, and a control unit (handover processing unit) 16, in the same manner as in the video transmission terminal 10 of the first embodiment. Furthermore, the video receiving device 20 of the present embodiment includes a reproduction control unit 25 for the purpose of controlling the display on the display unit 24, in addition to the configuration of the video receiving device 20 of the first embodiment.

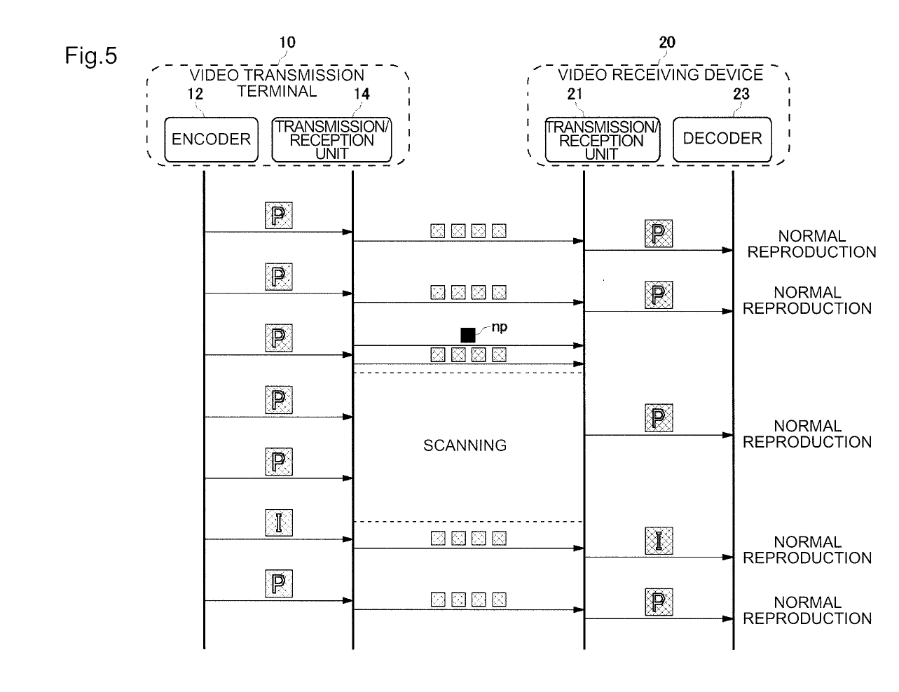

FIG. 5 is a sequence diagram illustrating a video data transfer of the present embodiment. The handover processing unit 16 of the present embodiment scans two access points in each segmented scan. The time required for the segmented scan is twice or more and less than three times a frame interval in the transmission of video data. Thus, the handover processing unit 16, in the same manner as in the first embodiment, cancels the transmission of the video data frames to be transmitted during the segmented scan, and the number of frames to be canceled is two. That is, the handover processing unit 16 discards two frames of video data during a single segmented scan.

The handover processing unit 16 performs the segmented scan at the transmission timing of two frames immediately before an I frame. That is, the segmented scan is started after the transmission of a P frame that is three frames before the I frame. As a result, in the same manner as in the first embodiment, the first frame to be transmitted after the segmented scan will be the I frame. The I frame, after being received on the receiving side, can be reproduced immediately without referencing another frame.

Moreover, the handover processing unit 16 of the present embodiment transmits advance notice information on the segmented scan to the video receiving device 20, before starting the segmented scan. This advance notice is a reminder that, after a predetermined number of frames of the video data are transmitted following the advance notice, there will be a time period involving no transmission of the video data because of the segmented scan. A packet np containing the advance notice information is transmitted prior to the last video data frame to be transmitted before starting the segmented scan.

In the video receiving device 20, when a transmission/reception unit 21 receives the advance notice information, the reproduction control unit 25 controls the reproduction of the video in response to the received information. Specifically, the reproduction control unit 25 controls a decoder 23 so that the timing for the decoder 23 to read the frame that precedes the segmented scan after the advance notice, from a buffer unit 22, may slightly be delayed. This slightly delays a decoding process on the decoder 23 and a display process on the display unit 24 for the frame preceding the segmented scan and after the advance notice.

In the case where there is no advance notice, the video data of the last frame that precedes the start of the segmented scan is immediately decoded and displayed after reaching the video receiving device 20. This may cause an inconvenience that the video pauses for a relatively long time (until the segmented scan ends thereafter and the video data is decoded and displayed) at the last frame that precedes the start of the segmented scan. Particularly in the present embodiment in which two channels are scanned by one segmented scan that takes a relatively long time, the pausing of the video for a long time may cause uneasiness for the user.

To avoid the pausing of the video for a relatively long time, the timings of decoding and display for the frame preceding the start of the segmented scan are delayed to disperse the frame intervals for the video to be reproduced, enabling smaller variations between the frame intervals. To achieve this, the video transmission terminal 10 transmits the advance notice information to the video receiving device 20 prior to the segmented scan.

In an example illustrated in FIG. 5, the video transmission terminal 10 transmits the advance notice information np of the segmented scan prior to the last one frame before the start of the segmented scan. Alternatively, however, the advance notice information of the segmented scan may be transmitted prior to the last two or more frames before the start of the segmented scan. This makes it possible to achieve smaller variations between the frame intervals.

Furthermore, the advance notice information may include not only the advance notice to start a segmented scan but also information of how many frames of the video data are to be transmitted after the advance notice, the length of time to be taken for the segmented scan, and information of how many frames of the video data to be transmitted are to be canceled for the segmented scan. In this case, based on the information received, the reproduction control unit 25 of the video receiving device 20 can determine the degree of delays in the timings of the decoding and of the display. In the case where the transmission of the advance notice is predetermined to occur at certain frames preceding the segmented scan, and in the case where the length of the segmented scan is predetermined, the reproduction control unit 25 causes delays in the decoding and display of the frame that has been received prior to the segmented scan after the advance notice, the duration of the delays being computed using the information.

As described above in the second embodiment of the present invention, similar effects to the first embodiment can be achieved. In addition, transmitting the advance notice information of the segmented scan from the video transmission terminal 10 to the video receiving device 20, before starting the segmented scan, enables the video receiving device 20 to cause a delay in response to the advance notice in the timing of display of the frame prior to the segmented scan after the advance notice, thereby achieving smoother display of the video.

In the above first and second embodiments, the handover processing unit 16 counts the number of the P frames following the transmission of the I frame, and determines that the P frame that comes two or three frames before the I frame has been transmitted. However, if the buffer unit 13 has a capacity to temporarily store two or more frames of the video data including the I frame, the handover processing unit 16 may detect that the intra-frame coding has been conducted in the encoder 12 and may cancel transmission of the P frame that is stored in the buffer unit 13 and comes one or two frames before the I frame.

Furthermore, in the above first and second embodiments, 14 channels are prepared in the video transfer system 100 or in the video transfer system 200. Therefore, the segmented scans are performed for all the 14 channels. However, there may be situations in which the coverage area of each access point does not necessarily overlap the coverage areas of the other 13 access points, and thus the number of access points available for handover from where the video transmission terminal 10 exists may be about four or five, for example, not necessarily 13. Accordingly, the access points to be scanned for handover may be limited to the access points to which the handover can take place and the access points already in connection.

In this case, the number of times of the segmented scans is not 14 times, but limited to the number of access points to which the handover can take place. For this, each access point may have the information on the channels for the adjacent access points. For example, assuming that there are access points AP2 to AP6 (channels 2 to 6) being adjacent to the access point AP1 and having overlapping coverage areas with the access point AP1, information on the access points AP2 to AP6 (channels 2 to 6) is stored at the access point AP1, as the potential access points for handover.

When the scans are performed at the video transmission terminal 10 connected to the access point AP1, the video transmission terminal 10, after having obtained the information from the connected access point AP1 that the access points to be scanned would be AP2 to AP6, performs segmented scans for the channels 1 to 6, according to the obtained information. In this case, the access points AP1 to AP6 will be the plurality of access points to be scanned for handover.

In the above first and second embodiments, the scan for each channel is implemented as an active scan, in which a probe request Rq is sent to the access point to be scanned, and a probe response Rs is received from the same access point. The scan for each channel, however, may be implemented as a passive scan, in which the reception channel is simply tuned to the frequency of the access point to be scanned, and a probe signal is received from the same access point.

Furthermore, in the above first and second embodiments, transmission of all the frames to be transmitted during the segmented scan is canceled; however, if there is a plurality of frames to be transmitted during the segmented scan, the transmission of only a portion of the frames may be canceled.

Furthermore, in the above first and second embodiments, the video transmission terminal 10 includes a configuration for imaging an object and producing video data, including the image capture unit 11 and the encoder 12, and another configuration for transmitting the produced video data, including the transmission/reception unit 14. However, the video transmission terminal 10 may include a first device and a second device respectively having the configuration for imaging an object and producing video data, and the configuration for transmitting the produced video data, including the transmission/reception unit 14. In this case, the video data produced on the first device is transmitted to the second device via a transmission line or by using short-range wireless communication, and then the video data is transmitted from the second device to an access point.

Presently preferred embodiments of the present invention have been described as above, and it is possible to apply various modifications to the present embodiments. It is therefore to be understood that the appended claims are intended to cover all such modifications falling within the true spirit and scope of the invention.

### INDUSTRIAL APPLICABILITY

The present invention has an effect to suppress deterioration of a video in the reproduction of the video on a video receiving device which receives video data, and is useful as a video transmission terminal or the like that transmits the video data to the video receiving device via any of a plurality of access points.

### REFERENCE SIGNS LIST

100, 200 video transfer system
10 video transmission terminal
11 image capture unit
12 encoder
13 buffer unit
14 transmission/reception unit
15 RSSI measurement unit
16 control unit (handover processing unit)
20 video receiving device
21 transmission/reception unit
22 buffer unit
23 decoder
24 display unit
25 reproduction control unit

1. A video transmission terminal comprising:
a transmission unit configured to transmit video data to a video receiving device via any of a plurality of access points; and
a handover processing unit configured to scan the access points for handover,
wherein the transmission unit is configured not to transmit at least some of frames of the video data to be transmitted during the scan.

2. The video transmission terminal according to claim 1,
wherein the handover processing unit scans the access points, the scan being segmented into a plurality of times of scans.

3. The video transmission terminal according to claim 1,
wherein the frame of the video data that is not to be transmitted is a frame immediately before an intra-frame coding frame.

4. The video transmission terminal according to claim 1, configured to transmit an advance notice of the scan to the video receiving device before performing the scan.

5. A tangible computer readable storage medium encoded with an executable computer program for transmitting video and that, when executed by a processor, causes the processor to perform operations comprising:
transmitting video data to a video receiving device via any of a plurality of access points; and
scanning the access points for handover,
wherein, at least some of frames of the video data to be transmitted during the scan is not transmitted.

6. A video transmission method comprising:
a transmission step of transmitting video data to a video receiving device via any of a plurality of access points; and
a handover processing step of scanning the access points for handover,
wherein in the transmission step, at least some of frames of the video data to be transmitted during the scan is not transmitted

7. A video transfer system comprising:
a video transmission terminal; and
a video receiving device,
the video transfer system being configured to transfer video data from the video transmission terminal to the video receiving device,
wherein the video transmission terminal includes:
a transmission unit configured to transmit the video data to the video receiving device via any of a plurality of access points; and
a handover processing unit configured to scan the access points for handover,
the transmission unit is configured not to transmit at least some of frames of the video data to be transmitted during the scan, and configured to transmit an advance notice of the scan to the video receiving device before performing a segmented scan, and
the video receiving device includes:
a reception unit configured to receive the video data and the advance notice;
a reproduction unit configured to reproduce the video data; and
a reproduction control unit configured to, in response to the advance notice, adjust the timing of reproducing, by the reproduction unit, the video data that has been received after the advance notice and before the scan.

8. The video transmission terminal according claim 2, configured to transmit an advance notice of the scan to the video receiving device before performing the scan.

9. The video transmission terminal according claim 3, configured to transmit an advance notice of the scan to the video receiving device before performing the scan.
